(19) United States
(12) Patent Application Publication
(10) Pub. No.: US 2016/0338325 A1
(43) Pub. Date: Nov. 24, 2016

(54) STRUCTURE OF THE FILTER ASSEMBLY OF A BEESWAX SEPARATION SCREW

(71) Applicant: PARADISE HONEY OY, Porvoo (FI)

(72) Inventor: Juhani VAARA, Porvoo (FI)

(73) Assignee: PARADISE HONEY OY, Porvoo (FI)

(21) Appl. No.: 15/113,959

(22) PCT Filed: Jan. 23, 2015
(86) PCT No.: PCT/FI2015/000004

§ 371 Date: Jul. 25, 2016

(30) Foreign Application Priority Data
Jan. 24, 2014 (FI) U20140012

(51) Int. Cl. A01K 59/06; A23L 5/20; B30B 9/12; A23L 21/25

(52) U.S. Cl. CPC A01K 59/06; A23L 21/25; A23L 5/20; B30B 9/12; A23V 2002/00

(57) ABSTRACT

The structure of the filter assembly of the beeswax separation screw includes cylindrical filter components attached to each other one after the other. One of these filter components includes a cylindrical filter pipe, at the ends of which are mounted flanges. The filter components are tightly attached with bolts so that opposite flanges of the filter components mounted one after the other settle against each other. The first filter component of the structure is open at its top under a feed hopper and the following filter components are closed, the sides of all filter components having small holes, through which the increasing pressure forces the honey out. The other end of the filter component is mounted to the body of the beeswax separation screw. The structure is beneficial when including only two filter components in which case the first component includes the whole length of the compression zone.

### TECHNICAL FIELD

The present invention relates to a method of beekeeping for separating wax and honey of the honeycombs built by bees, so that in the end of the separation process the filtered honey contains the least amount possible of beeswax. To carry out this process a beeswax separation screw can be used, for which a new structure for a filter assembly is hereby invented. This improvement significantly facilitates the tailoring of the beeswax separation screw for different varieties of honey and its compositions, and the maintenance and cleansing of the present beeswax separation screw compared to the traditional structure of the beeswax screw presented in the publication U.S. Pat. No. 5,715,747A.

### BACKGROUND AND KNOWN TECHNOLOGY

After uncapping honeycombs, the collected mixture contains honey and wax, wherefrom the honey must be separated with the help of a beeswax separation screw. In the best case scenario, the percentage of honey in the separated beeswax is less than one percent. The separation of beeswax from honey can be made beneficially in the following way: the mixture of honey and beeswax is poured into a hopper cone of the beeswax separation screw to an open, cylindrical filter pipe underneath it. There is a rotating, screw-like compressing part inside the filter pipe. The compressing part moves the mixture of honey and beeswax forward in the tube. The diameter of the core in the spiral of the compressing part becomes larger and the pitch of the spiral increases toward its end, so that the space for the mixture of wax and honey becomes smaller as the mixture moves forward in the filter pipe, where the pressure of the mixture increases toward the end of the pipe. Because of the increasing pressure, honey is squeezed through the little holes of the filter pipe and pours into a honey tank. At the same time, squeezed dry beeswax exits from the end of the beeswax separation screw as a continuous spiral.

The traditional beeswax separation screw presented in the publication U.S. Pat. No. 5,715,747A, has an area underneath the hopper cone, parallel to its longitudinal axis, which is called a feed zone, and the back end of the separation screw, parallel to its longitudinal axis, is called a compression zone. If the filter component has been damaged or it has to be removed for example for maintenance, is this removal of the component rather difficult and, in case of damage, replacing the whole filter pipe component is often necessary. Moreover, it is often necessary to filter different varieties of honey having a different viscosity with the same beeswax separation screw. For this, it would be practical to effortlessly change the filter component that corresponds the best for each honey type to ensure the best result possible. The filter component of the traditional beeswax separation screw cannot be changed, and therefore several beeswax separation screws according to the variety of honey and sometimes for crystallized honey as well, would be needed to ensure the optimal separation result.

### SUMMARY OF THE INVENTION

The aim of this invention is the new structure of the filter assembly of the beeswax separation screw that separates honey from wax and allows an easy maintenance of the filter and also enables changing the components of the filter when needed. This new structure of the filter assembly of the beeswax separation screw enables thereby that with a single beeswax separation screw both different varieties of honey and partially also the crystallized honey can be filtered. The use of an optimal filter for each honey variety in the beeswax separation screw means, in other words, that more honey is collected than by using a traditional beeswax separation screw. By an optimal filter component is meant the optimal size and shape of the filtering holes of the filter component and the optimal spacing of the filtering holes.

The new structure of the filter assembly that separates honey from wax comprises several filter components that are installed closely one after the other. One of these filter components consists of cross-sectionally round, cylindrical filter pipes, to the both ends of which flanges are mounted for tight installation. There are small holes on the filter pipe for squeezing the filtered honey out. The filter components are mounted one after the other and installed tightly against each other with the help of bolts so that the flanges of the opposite filter components are placed against each other. Counted from the mounting surface of the body and the filter, the other end of the first filter component is attached to the body of the beeswax separation screw by bolts and is therefore removable and exchangeable if needed.

Characteristic to one implementation example of the present invention is that the filter assembly of the beeswax separation screw composes of three filter components, from which the first one is open at its top and is located under the feed hopper and this part comprises the whole feed zone. The second filter component comprises the beginning of the compression zone and third filter component the end of the compression zone.

Characteristic to one beneficial implementation example of the present invention is that the filter assembly of the beeswax separation screw composes of two filter components, the first one of which is open at its top and is located under the feed hopper and this component comprises the whole feed zone. The second component extends over the whole length of the compression zone.

### BRIEF DESCRIPTION OF DRAWINGS

In the following the invention is described more in detail with a beneficial implementation example illustrated on the accompanying drawing, wherein:

FIG. 1: A section view of the beeswax separation screw and the structure of the new filter assembly for beeswax. In the hereby illustrated implementation example, the filter assembly of the beeswax separation screw composes of three filter components.

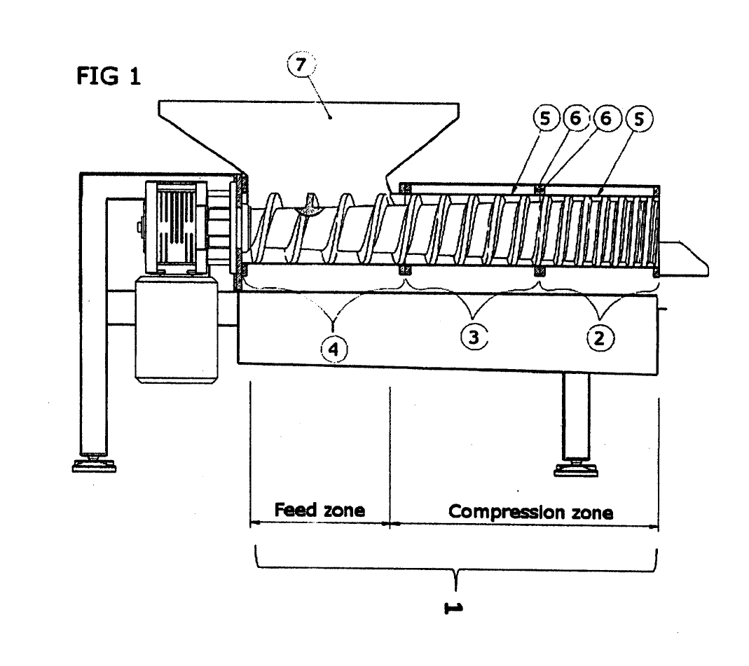

1-3. (canceled)

4. Structure of a filter assembly of the beeswax separation screw, wherein the structure comprises two or three tightly attached, cylindrical filter components mounted one after the other, a first filter component of which being open at its top under a feed hopper.

5. Device according to claim 4, wherein the structure of the filter assembly of the beeswax separation screw, wherein in the filter components there are flanges at both ends of filter pipes.

6. Structure of the filter assembly of the beeswax separation screw according to claim 5, wherein at the both ends of the filter components there are flanges having attachment holes for the bolts with the help of which the filter components are attached to each other to form one solid filter.
